(19) United States
(12) Patent Application Publication
(10) Pub. No.: US 2005/0208194 A1
(43) Pub. Date: Sep. 22, 2005

(54) Method for producing a beverage syrup and a refreshing beverage prepared from said syrup

(76) Inventors: Ian Valovic, Donnerskirchen (AT); Vladimir Nuhlicek, Donnerskirchen (AT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/515,402

(22) PCT Filed: May 21, 2003
(86) PCT No.: PCT/EP03/05326

§ 371 Date: Jun. 2, 2005

(30) Foreign Application Priority Data
May 24, 2002 (AT) A 798/2002

(51) Int. Cl. C12C 1/00

(52) U.S. Cl. 426/590

(57) ABSTRACT

The invention relates to a method for producing a beverage syrup and to a refreshing beverage prepared from said syrup, in particular a refreshing carbonated beverage. The beverage syrup contains sweetened must and a flavouring as the main constituents, which in turn comprise wine and a flavouring macerate that contains vegetable flavouring Ingredients as their main constituents.

The present invention relates generally to a method of producing a beverage syrup and to a refreshing beverage prepared therefrom, especially a carbonated refreshing beverage.

The object of the present invention is to provide a method of making a beverage syrup whose main components are must and wine (white wine or red wine) and which contains a macerate of aromatizing or flavoring plant components or a refreshing drink which is produced therefrom by mixing it with water and adding carbon dioxide.

The method of the invention is characterized by the following steps:
(a) producing a sweetened must,
(b) producing an aromatizing or flavoring macerate with subsequent processing to aroma or flavoring components,
©) processing the sweetened must and the aromatizing or flavoring to a beverage syrup with mixing at least one organic acid, optionally with salt, optionally with a coloring agent and with potable water therewith and then filtering and optionally,
(d) mixing of water and this beverage syrup whereby prior to and/or after the mixing, a pasteurization is carried out and carbon dioxide is added to produce the refreshing beverage.

In a special embodiment of the method, the sweetened must in step ©) is desulfurized prior to the further processing to the heavy syrup. The organic acid added in step ©) can be drawn from the field of known organic acids which are acidification agents or antioxidants, for example tartaric acid, citric acid, ascorbic acid and mixtures from that group. The coloring agent which is optionally used can be a natural coloring agent.

In the optional step (d), water and the beverage syrup which is obtained, optionally separately, are pasteurized, i.e. heated each to a temperature of 70° to 80° C., preferably 73° to 75° C. and directly thereafter cooled to a temperature of less than 5° C., preferably 2 to 3° C.

The production of the refreshing beverage according to the invention can be carried out in a so-called premix apparatus which has a venting unit, a saturation unit for the injection of carbon dioxide and a mixing unit. After the mixing of the pasteurized water with the pasteurized beverage syrup the cooled beverage can be saturated with the carbon dioxide or a nonpasteurized mixture can be passed through a continuous pasteurizer and saturated with carbon dioxide. The refreshing beverage produced in accordance with the invention can be packaged in a conventional filling plant.

According to a further feature of the invention, a sweetened must as has been indicated is suitable for use in the method initially described, can be produced as follows: Must can be mixed with refined sugar and at least one organic acid, like, for example citric acid, this mixture optionally sulfurized and then filtered, for example through a Kremelin filter. A treatment with agents to improve appearance is not required.

In the case of a sulfurization of the sweetened must, a sulfur content of up to 500 mg/l can be tolerated. Because of this relatively high sulfur content, the sweetened must produced in accordance with the invention can be stored for a long time, for example it can be kept without spoilage for about a year in enameled steel tanks.

The sweetened must which is used can be a must made from grapes, especially a grape must of the Müller-Thurgau type. Such a must recovered directly following the pressing is optionally highly sulfurized and is decanted after several hours, about 12 to 18 hours, and centrifuged for the removal of undesirable impurities. The thus pretreated must can then be sweetened as described above.

According to a further feature of the invention, an aroma or flavoring component like that which is used for the production of the refreshing beverage or beverage syrup according to the invention, can be produced by mixing an aromatizing or flavoring macerate with wine, at least one completing component, optionally at least one coloring agent and optionally with an appearance improving agent and this mixture can be optionally sulfurized to limit spoilage and then filtered. Preferably the completion component is selected from the group which consists of nutmeg or muscatel pulp, brandy, sugar color (Zucker-Couleur) and mixtures thereof. The coloring agent used can be a natural coloring agent. The use of the appearance-improving agent, for example tannin, can be especially advantageous in the production of an aroma or flavoring component using red wine.

The wine used for mixing with the aromatizing or flavoring macerate can be a relatively high quality wine, which in o0 the case of a white wine can for example be selected from the group of Traminer, Rheinriesling, Welsch-riesling, Müller-Thurgau and mixtures thereof and in the case of the use of red wine can be selected for the group of Zweigelt, Blaufränkish, Blauburgunder and mixtures of white wine and red wine can also be used.

According to a further feature of the invention, an aromatizing or flavoring macerate as has especially been described in the method of the invention for the production of the aroma component, can be made as follows:
aromatizing or flavoring plant components can be mixed with water, optionally with sugar, with at least one organic acid like for example citric acid and/or tartaric acid and optionally with sweetened must produced according to the invention.

To this system a yeast suspension can be added and support can be subjected to a multi-day fermentation process, whereby the fermentation is for example carried out in rotating tanks or the stirring then the mixture, for recovering a pressed juice is pressed and the pressed juice is clarified, filtered and the filtrate is optionally sulfurized. In the case of a sulfurization, the sulfur addition should be such that the free sulfur content amounts to up to 40 mg/l. The clarification can be effected for example by adding an agent to improve the appearance or clarity, such as bentonite, the bentonite being typically sued in an amount of 100 g/hl.

The aromatizing or flavoring plant or vegetable components can, according to a further feature of the invention be fresh or dried elderberry blossom, (Sambucus nigra) and the added yeast culture can be wine yeast.

In the following recipes for the preparation of the sweetened must, the aromatizing or flavoring macerate, the aroma component, the beverage syrup and the refreshing drink in accordance with the method of the invention are given along with typical composition ranges of the mentioned products.

Advantageously in the method according to the invention potable water in accordance with prevailing standards can be used.

According to the method of the invention, a sweetened must, like for example, sweetened grape must 52°RF, specific gravity 1.243 (60 to 70 g/100 ml), is prepared approximately in accordance with the following recipe (Amounts per 100 L): Pure grape must Specific gravity

| | | |
|---|---|---|
| 1.061-200 g/l | 68.0 to 68.9 L | (72 to 75 kg) |
| Refined sugar | 51.98 to 52.17 kg | (31 to 32 L) |
| Citric Acid | 7 to 13 g/l | (0.65 to 0.75 kg) |

The refined grape must made in this manner has the following characteristics:

| Refraction, 20° C. | 52Rf | |
|---|---|---|
| Tartaric Acid | 10 to 12 | g/l |
| Volatile Acids | 0.6 to 0.9 | g/l |
| Free SO₂ | 250 to 300 | mg/l |

According to the method of the invention, elderberry blossoms (Sambucus nigra) can be prepared as the aromatizing or flavoring plant component in the form of aromatizing or flavoring macerate, specific gravity 0.992 to 0.997 in accordance with the following recipe (amounts per 100 1):

| | | |
|---|---|---|
| Fresh elderberry blossoms | 6.48 to 12 | kg |
| Sweetened must | 33.25 to 34.00 | l |
| Potable water | 63.95 to 64.55 | l |
| Yeast suspension | 1.9 to 2.1 | l |
| Citric acid and/or tartaric acid | 0.18 to 2.2 | kg |

An elderberry blossom aromatizing or flavoring macerate so produced can have for example the following content:

| Alcohol | 8 to 10% | |
|---|---|---|
| Free SO₂ | 25 to 35 | mg/l |
| Tartaric acid | 4 to 8 | g/l |
| Volatile acids | 1 to 1.4 | g/l |

According to the method of the invention, using an elderberry blossom based aromatizing or flavoring macerate and a white wine, for example, an aroma component with a density or specific gravity of 0.994 to 0.998 can be prepared in accordance with the following recipe (Amounts per 100 kg):

| 1 Part elderberry blossom aromatizing | together 92.9 to 93.6. | |
|---|---|---|
| macerate and 2 Parts white wine | | |
| Muscatel pulp 40% | 4.4 to 4.6 | kg |
| Brandy (bonif. 50%) | 0.9 to 0.95 | kg. |
| Sugar couleur | 0.6 to 0.7 | kg |
| Lemon yellow coloring | 0.01 to 0.03 | kg. |
| Emerald green coloring | 0.0011 to 0.0015 | |

kg

The aroma component thus made can have for example the following contents:

| Alcohol | max. 14% | |
|---|---|---|
| Tartaric acid | 5 to 8 | g/l |
| Volatile acids | 1 to 1.4 | g/l |
| Free S0₂ | 30 to 45 | mg/l |
| Total SO₂ | 200 to 260 | mg/l |

Advantageously, using such an elderberry blossom aromatizing or flavoring macerate and a red wine, an aroma component can be prepared with the following recipe (Amounts per 100 kg):

| 1 Part elderberry blossom aromatizing macerate | together 92.9 to 93.6. | |
|---|---|---|
| or flavoring macerate and 2 Parts red wine | | |
| Muscatel Pulp 40% | up to 4.0 | kg |
| Brandy | up to 0.9 | kg. |
| Sugar couleur | up to 0.9 | kg |
| Brandy brown coloring agent | up to 5 | g |
| Tannin | up to 4 | g |

According to the method of the invention, a beverage syrup, specific gravity 1.220 to 1.228, for example using the above aroma component which is made with the use of white wine, is prepared in accordance with the following recipe (Parts per 100 1):

| | | |
|---|---|---|
| Sweetened grape must 52 Rf | 86.0 to 87.0 | kg (69 to 70 l) |
| Aroma Component (Sambucus | 9.50 to 9.65 | kg (9.55 to 9.7 l) |
| Nigra) | | |
| Tartaric Acid | 0.4 to 0.48 | kg (0.25 to 0.28 l) |
| Citric Acid | 1.3 to 1.5 | kg |
| Ascorbic Acid | 0.0042 to 0.0047 | kg |
| Salt (NaCl) | 0.123 to 0.139 | kg |
| Potable Water | 1.2 to 1.9 | kg. |

Such a beverage syrup can have for example the following contents and characteristics:

| Dry substance proportion | 45% ± 0.5 | |
|---|---|---|
| Tartaric acid | 20 to 25 | g/l |
| Total SO₂ | max 25 | mg/l |
| Density or specific gravity | 1.2 | |

From that syrup a beverage can for example be made with the following contents and characteristics, whereby about 25 to 15 vol. % syrup and about 75 to 85 volume % potable water are mixed:

| Dry content | 6.0 to 9.7 | |
|---|---|---|
| Tartaric acid | 2.1 to 4.5 | g/l |
| CO₂ | 4.1 to 6.4 | g/l |
| SO₂ | 12.3 to 16.7 | g/l |
| Alcohol | 0.2 to 0.4% | |
| Refraction 20° C. | 7.5 to 10.4 | Rf |

In accordance with the method of the invention, a beverage syrup, using an aroma component as has been described above can be made using a red wine for example in accordance with the following recipe (Amounts per 100 1):

| | | |
|---|---|---|
| Sweetened grape must 52Rf | 86.0 to 87.0 | kg (69 to 70 l) |
| Aroma Component | 9.50 to 9.65 | kg (9.55 to 9.7 l) |
| (Sambucus Nigra) | | |
| Tartaric Acid | 0.4 to 0.48 | kg (0.25 to 0.28 l) |
| Citric Acid | 1.3 to 1.5 | kg |
| Ascorbic Acid | 0.0042 to 0.0047 | kg |
| Burgundy Red | | |
| Coloring Agent | 9 to 1 | g |
| Potable Water | 1.2 to 1.9 | kg |

The advantages of the invention, apart from an unusual stability of the sweetened must, the aromatizing macerate or flavoring macerate, the aroma component and the beverage syrup or refreshing beverage made therefrom include a good taste of the beverage, that is their fruitiness and the fact that it has no so-called cooked taste. A further advantage is that natural wines and musts as well as aromatizing or flavoring plant components from controlled ecological sites can be used. The refreshing beverage made according to the invention can be designated as alcohol free. The products can keep for about a year.

1. A method of producing a refreshing beverage or a beverage system which can be used therefore, whereby the beverage syrup is miscible with water and carbon dioxide to the finished refreshing drink, which method is characterized by:
(a) producing a sweetened must,
(b) producing an aromatizing flavoring macerate with subsequent further processing to an aroma component,
©) processing of the sweetened must and the aroma component to a beverage syrup by mixing them with at least one organic acid, optionally with salt, optionally with a coloring agent and with potable water and then filtering and optionally,
(d) mixing water and this beverage syrup whereby before and/or after mixing the components are pasteurized and carbon dioxide is injected to produce the refreshing beverage.

2. The method according to claim 1 characterized in that sweetened must before further processing is desulfurized in step ©).

3. The method according to claim 1 characterized in that the organic acid in step ©) is selected from tartaric acid, citric acid, ascorbic acid and mixtures thereof.

4. The method according to claim 1 characterized in that the coloring agent optionally used in step ©) is a natural coloring agent.

5. The method according to one claim 1 characterized in that in step (d) the water and heavy syrup optionally separately are pasteurized whereby they are heated to 40° to 80° C., preferably 73° to 75° C. and directly thereafter are cooled down to a temperature of less than 5° C. preferably 2 to 3° C.

6. The method according to claim 1 characterized in that to produce the sweetened must optionally sulfur containing must is mixed with refined sugar and optionally with at least one organic acid, and this mixture is optionally sulfurized and then filtered.

7. The method according to claim 6 characterized in that the must which is used is a grape must for example of Müller-Thurgau grapes.

8. The method according to claim 6 characterized in that as the organic acid, citric acid is used.

9. The method according to claim 1 characterized in that to produce the aromatic component, an aromatizing or flavoring macerate is mixed with wine, at least one completing component, optionally with at least one coloring agent and optionally with an agent improving the appearance, this mixture being optionally sulfurized and then filtered.

10. The method according to claim 9 characterized in that the completion component is selected from muscatel pulp or residue, wine brandy, sugar couleur and mixtures thereof.

11. The method according to claim 9 characterized in that the wine used is a white wine, red wine or a mixture thereof.

12. The method according to claim 10 characterized in that the white wine is from the group of Traminer, Rheinriesling, Welsch riesling, Müller-Thurgau and mixtures thereof and/or the red wine is selected from the group of Zweigelt, Blaufränkisch, Blauburgunder and mixtures thereof.

13. The method according to claim 9 characterized in that natural coloring agents are used.

14. The method according to claim 9 characterized in that the appearance improving agent is tannin.

15. The method of producing an aromatizing or flavoring macerate, especially for use in a process according to claim 1 characterized by
mixing aromatizing or flavoring plant components with water, optionally sugar, at least one organic acid and optionally with sweetened must, preferably made in accordance with one or more of claims 6 to 8, adding a yeast suspension to the mixture,
carrying out a multiday fermentation of the mixture,
pressing the mixture to recover a pressed juice therefrom,
clarifying the pressed juice,
filtering the pressed juice and
optionally sulfurizing the filtrate.

16. The method of claim 15 characterized in that the aromatizing or flavoring plant components are fresh or dried elderberry blossoms (Sambucus nigra) and the yeast culture is a wine making yeast

17. The method according to claim 15 characterized in that the organic acid is citric acid and/or tartaric acid.

18. The method according to claim 15 characterized in that the pressed juice is clarified by the addition of bentonite.

19. A refreshing beverage made in accordance with a method according to claim 1.
